(19) United States
(12) Patent Application Publication
(10) Pub. No.: US 2014/0138971 A1
(43) Pub. Date: May 22, 2014

(54) CLAMPING MECHANISM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HAI-FANG XIE, Shenzhen (CN); ZHAO-QIAN ZHANG, Shenzhen (CN); YING-JUN PENG, Shenzhen (CN); WEN-JIE LANG, Shenzhen (CN); FU-GUO ZHU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/078,528

(22) Filed: Nov. 13, 2013

(30) Foreign Application Priority Data
Nov. 21, 2012 (CN) 2012104745743

(51) Int. Cl. B25J 15/00

(52) U.S. Cl. CPC B25J 15/0047
USPC 294/195

(57) ABSTRACT

A clamping mechanism includes a supporting seat, a clamping assembly, and a pushing assembly. The clamping assembly includes a fixing member, four clamping members, and a limiting member. The fixing member is fixedly received in the supporting seat and defines a receiving hole therein. The four clamping members are partially received in the receiving hole and protrude out of the fixing member. The limiting member is sleeved around the four clamping members. The pushing assembly includes an adjusting seat, an elastic member, and a pushing member. The elastic member is received in the adjusting seat. The pushing member is partially received in the adjusting seat, and an end of the pushing member away from the adjusting seat is surrounded by the four clamping members and resists the four clamping members outwardly.

### BACKGROUND

1. Technical Field

The present disclosure relates to a clamping mechanism, and more particularly to a clamping mechanism to clamp a workpiece having a hole.

2. Description of Related Art

Clamping mechanisms are employed to clamp a workpiece which has a hole defined therein, for moving and handling the workpiece. The clamping mechanism is assembled to a distal end of a robot arm, and clamps the workpiece by the hole of the workpiece. The clamping mechanism includes a driving member, a plurality of clamping members, and a pushing member interconnecting the driving member and the plurality of clamping members. When in use, the clamping members are driven by the robot arm to enter into the hole of the workpiece, and the driving member drives the pushing member to push the clamping members outward to resist an inner sidewall of the hole and hold the workpiece. However, when an uneven amount of force is generated by the pushing member, the clamping members may deform due to a sudden change in the amount of force exerted on the clamping members by the pushing member, thereby reducing a service life of the clamping members. In addition, when the driving member does not exert enough force on the pushing member, the clamping members may not resist the inner sidewall of the hole tightly enough, and thereby drop the workpiece.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a clamping mechanism.

FIG. 2 is an exploded, isometric view of the clamping mechanism of FIG. 1.

FIG. 3 is similar to FIG. 2, but viewed from another aspect.

FIG. 4 is a cross-sectional view of the clamping mechanism of FIG. 1, taken along line IV-IV.

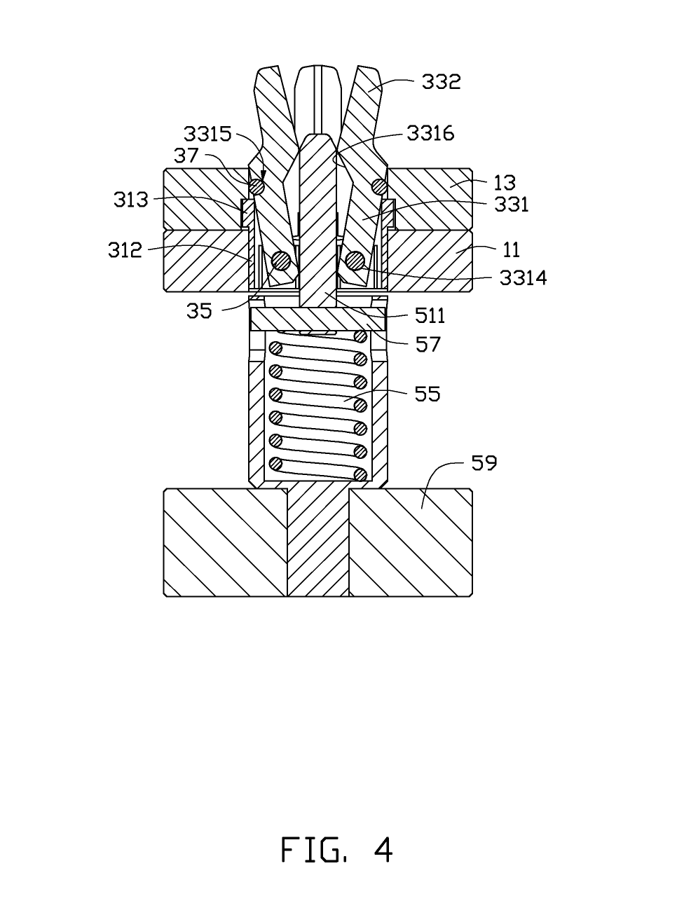

### DETAILED DESCRIPTION

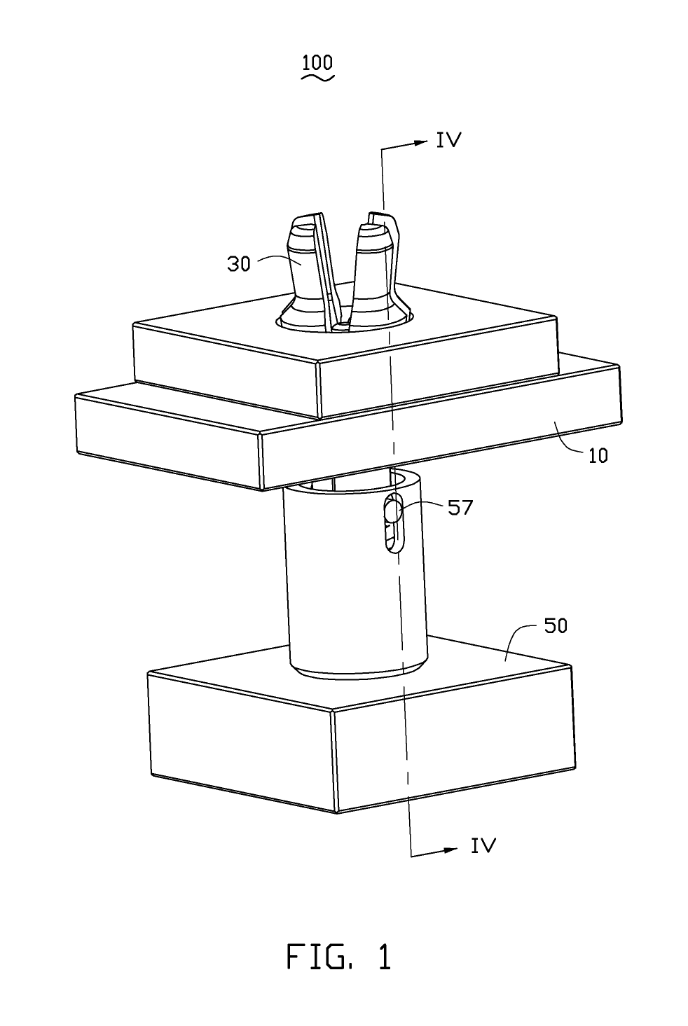

FIG. 1 shows an embodiment of a clamping mechanism 100 employed to clamp a workpiece (not shown). The workpiece defines a hole therein. The clamping mechanism 100 includes a supporting seat 10, a clamping assembly 30, and a driving assembly 50. The clamping assembly 30 extends through the supporting seat 10. The driving assembly 50 is connected to the clamping assembly 30 for driving the clamping assembly 30 to clamp the workpiece. The driving assembly 50 is assembled to a robot arm (not shown), and a distance between the supporting seat 10 and the driving assembly 50 can be adjusted to change a clamping force of the clamping assembly 30.

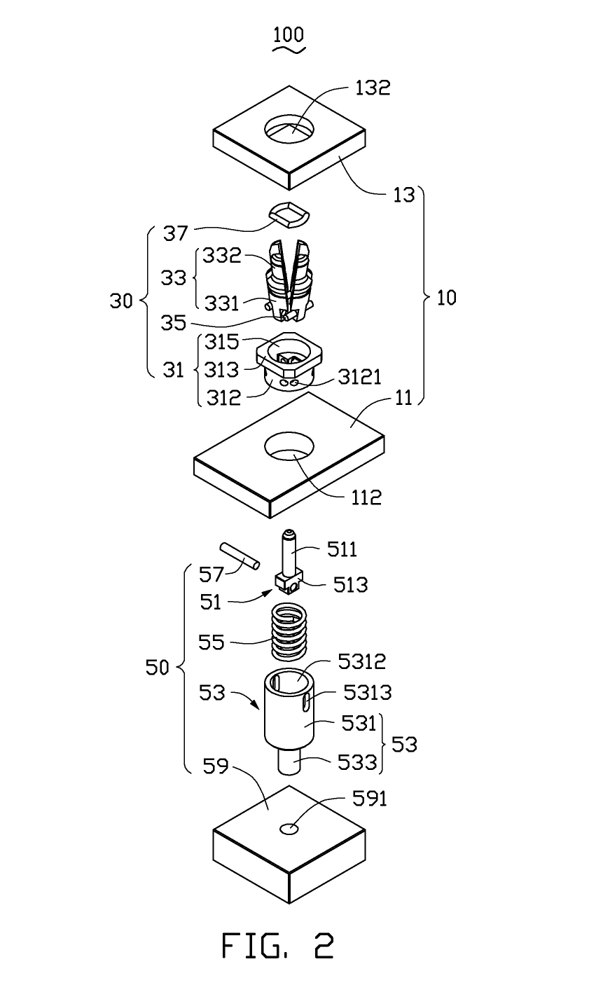

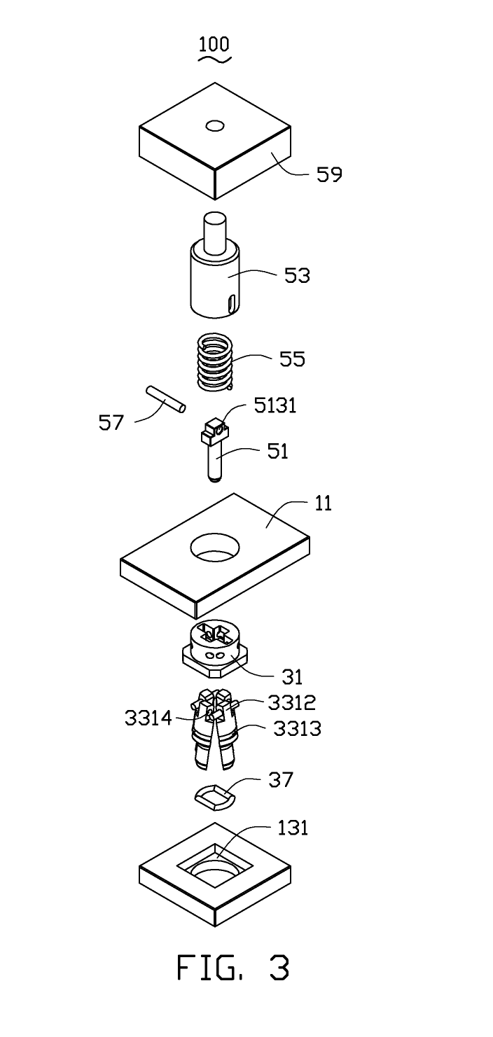

Referring to FIGS. 2 and 3, the supporting seat 10 includes a first mounting plate 11 and a second mounting plate 13 fixed on the first mounting plate 11. The first mounting plate 11 defines a first extending hole 112 in a middle portion thereof. A first surface of the second mounting plate 13 defines a fixing groove 131 facing the first mounting plate 11, and a second surface of the second mounting plate 13 defines a second extending hole 132 communicating with the fixing groove 131.

The clamping assembly 30 is assembled on the supporting seat 10, and includes a fixing member 31, four clamping members 33, four linking members 35 (only two linking members are shown in the figures), and a limiting member 37. The fixing member 31 is fixed to the supporting seat 10. The fixing member 31 includes a main body 312 and a fixing portion 313 surrounding a periphery of an end of the main body 312. The fixing member 31 defines a receiving hole 315 extending through the main body 312 and the fixing portion 313, respectively. The main body 312 is received in the first extending hole 112 of the first mounting plate 11, and the fixing portion 313 is received in the fixing groove 131 of the second mounting plate 13, and is clamped between the first mounting plate 11 and the second mounting plate 13. The main body 312 defines a plurality of pivotal holes 3121 thereon cutting through a periphery sidewall thereof. The four clamping members 33 are pivotably connected to the fixing member 31 by the four linking members 35. The four clamping members 33 are partially received in the receiving hole 315, and arranged uniformly around a periphery of the receiving hole 315.

Each clamping member 33 includes a base body 331 and a clamping portion 332 protruding from an end of the base body 331. The base body 331 includes a linking portion 3312 protruding from the base body 331 away from the clamping portion 332. An outer periphery of the base body 331 defines a mounting groove 3313 thereon, and a resisting surface 3316 is formed on an inner side of the base body 331 opposite to the mounting groove 3313. The mounting grooves 3313 of the four clamping members 33 cooperatively define a mounting space 3315. The resisting surface 3316 extends from the linking portion 3312 to the clamping portion 332, and is inclined toward a pushing member 51 of the pushing assembly 50. In the embodiment, the clamping portion 332 is movable relative to the base body 331. Each linking portion 3312 defines an extending hole 3314 thereon. Each linking member 35 is received in the receiving hole 315 and extends through the extending hole 3314 of one corresponding linking portion 3312 of the clamping member 33. Opposite ends of the linking members 35 are connected to the fixing member 31 by two pivotal holes 3121. The limiting member 37 is substantially annular, and is made of elastic materials. The limiting member 37 is sleeved around the base bodies 331 of the four clamping members 33, and received in the mounting space 3315. The limiting member 37 limits movement of the four clamping members 33 away from each other.

The pushing assembly 50 drives the four clamping members 33 to pivot away from each other. The pushing assembly 50 includes the pushing member 51, an adjusting seat 53, an elastic member 55, a sliding post 57, and an adjusting plate 59.

The pushing member 51 extends through the receiving hole 315 of the fixing member 31 to be surrounded by the four clamping members 33. The pushing member 51 includes a pushing portion 511 and a connecting portion 513 protruding from an end of the pushing portion 511. The pushing portion 511 is received in the receiving hole 315 and resists the resisting surface 3316 of the four clamping members 33. The connecting portion 513 is received in the adjusting seat 53 and defines an inserting hole 5131 thereon. The adjusting seat 53 is substantially a stepped cylindrical sleeve. The adjusting seat 53 includes a resisting portion 531 and an adjusting portion 533 coaxially protruding from an end of the resisting portion 531. The resisting portion 531 defines a receiving groove 5312 in an end thereof away from the adjusting portion 533, and a pair of sliding holes 5313 is defined in a periphery of the resisting portion 531. The sliding holes 5313 are opposite to each other and communicate with the receiving groove 5312.

The sliding post 57 is received in the receiving groove 5312 and extends through the inserting hole 5131 of the connecting portion 513 of the pushing member 51. Opposite ends of the sliding post 57 are slidably received in the pair of sliding holes 5313. In this embodiment, the elastic member 55 is a spring, and is received in the receiving groove 5312, such that the elastic member 55 is compressed between the sliding post 57 and a bottom wall of the receiving groove 5312 of the adjusting seat 53. The sliding holes 5313 are substantially oval-shaped, such that when the ends of the sliding post 57 are received in the sliding holes 5313, the sliding post 57 can slide along a length of the sliding holes 5313. The adjusting plate 59 is connected to the adjusting portion 533 of the adjusting seat 53. The adjusting plate 59 defines a screw hole 591, and the adjusting portion 533 is received in the adjusting plate 59 by screwing into the screw hole 591 of the adjusting plate 59. When the adjusting plate 59 is fixed to the robot arm, the adjusting portion 533 can be rotated to screw in or screw out of the screw hole 591, thereby adjusting a distance between the resisting portion 531 and the adjusting plate 59. Therefore, a resisting force between the pushing member 51 and the four clamping members 33 is adjusted. The robot arm drives the pushing assembly 50 to drive the pushing member 51 to resist the resisting surface 3316 of the four clamping members 33. Therefore, the four clamping members 33 are driven to move outwardly away from each other to clamp the workpiece.

In assembly, the main body 312 of the fixing member 31 is received in the first extending hole 112 of the first mounting plate 11. The fixing portion 313 of the fixing member 31 is received in the fixing groove 131 of the second mounting plate 13 and is clamped between the first mounting plate 11 and the second mounting plate 13. The four clamping members 33 are partially received in the receiving hole 315 of the fixing member 31, and arranged uniformly around the periphery of the receiving hole 315. The limiting member 37 is sleeved around the four clamping members 33 to be received in the mounting space 3315. The pushing portion 511 of the pushing member 51 extends through the receiving hole 315 and resists the resisting surfaces 3316 of the four clamping members 33. The elastic member 55 is received in the receiving groove 5312 of the adjusting seat 53. The connecting portion 513 of the pushing member 51 is received in the receiving groove 5312 and sleeved on the sliding post 57. Opposite ends of the sliding post 57 are slidably received in the pair of sliding holes 5313 of the adjusting seat 53 to compress the elastic member 55 in the receiving groove 5312. Finally, the adjusting portion 533 is screwed into the screw hole 591 of the adjusting plate 59.

When in use, the robot arm drives the clamping mechanism 100 toward the workpiece, the four clamping members 33 are received in the hole of the workpiece, and the second mounting plate 13 resists an outer surface of the workpiece. The robot arm drives the four clamping members 33 to rotate outwardly and resist an inner sidewall of the hole of the workpiece, such that the workpiece is held by the four clamping members 33 of the clamping mechanism 100. By rotating the pushing member 51 to adjust the distance between the pushing portion 511 and the adjusting plate 59, the resisting force of the four clamping members 33 on the inner sidewall of the hole of the workpiece is adjusted.

The limiting member 37 prevents the four clamping members 33 from moving outward uncontrollably, thereby avoiding the clamping members 33 from deforming due to a sudden change of the resisting force generated by the pushing member 51. Therefore, a service life of the clamping mechanism 100 is enhanced. The elastic member 55 is compressed between the pushing member 51 and the bottom wall of the receiving groove 5312. Therefore, the elastic member 55 is capable of pushing the pushing member 51 to resist the four clamping members 33, such that even if the workpiece at the hole thereof is not held tightly by the clamping members 33, the clamping members 33 are caused to resist the inner sidewall of the hole of the workpiece tightly. In addition, the elastic member 55 is capable of buffering contact between the clamping members 33 and the inner sidewall of the hole of the workpiece, thereby enhancing stability of the clamping mechanism 100.

A number of the clamping members 33 is not limited to four, but can be changed according to actual needs, and a number of the linking members 35 is changed according or corresponding to the number of the clamping members 33. When the adjusting portion 533 is assembled directly to the robot arm, the adjusting plate 59 may be omitted. When the linking portion 3312 of the clamping member 33 is rotatably connected to the fixing member 31 directly, the linking members 35 may be omitted. When the connecting portion 513 includes (additional structural elements in the form of) posts protruding from opposite sides of the connecting portion 513 and is directly connected to the pair of sliding holes 5313 by the posts, the sliding post 57 may be omitted.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A clamping mechanism for holding a workpiece having a hole therein, comprising:
a supporting seat;
a clamping assembly, comprising:
a fixing member fixedly received in the supporting seat and defining a receiving hole thereon;
at least two clamping members partially received in the receiving hole and protruding out of the fixing member; and
a limiting member sleeved on the at least two clamping members;
a pushing assembly comprising:
an adjusting seat;
an elastic member received in the adjusting seat; and
a pushing member partially received in the adjusting seat, wherein an end of the pushing member away from the adjusting seat is surrounded by the at least two clamping members and resists the at least two clamping members, when the supporting seat resists the workpiece, the adjusting seat pushes the pushing member to resist the at least two clamping members, such that the at least two clamping members rotate outwardly away from each other to resist an inner sidewall of the hole of the workpiece, thereby holding the workpiece.

2. The clamping mechanism of claim 1, wherein each clamping member comprises a base body and a clamping portion protruding from an end of the base body, the base body is rotatably received in the receiving hole of the fixing member, and the clamping portion is bent relative to the base body, and protrudes out of the fixing member.

3. The clamping mechanism of claim 1, wherein each clamping member defines a resisting surface, the resisting surfaces are inclined toward the pushing member, and the pushing member resists the at least two clamping members by the resisting surfaces of the clamping members.

4. The clamping mechanism of claim 1, further comprising at least two linking members, wherein each linking members is received in the receiving hole and extends through one corresponding clamping member, opposite ends of each linking member are rotatably connected to the fixing member.

5. The clamping mechanism of claim 2, wherein the base body of the clamping member defines a mounting groove at an outer periphery thereon, the mounting grooves of the at least two clamping members cooperatively form a mounting space, the limiting member is received in the mounting space to limit a rotation angle of the at least two clamping members away from each other.

6. The clamping mechanism of claim 1, wherein the supporting seat comprises a first mounting plate and a second mounting plate laminated on the first mounting plate, the second mounting plate is located at a side of the first mounting plate away from the adjusting seat, the fixing member is received in the first and the second mounting plates.

7. The clamping mechanism of claim 6, wherein the first mounting plate defines a first extending hole thereon, the second mounting plate defines a fixing groove facing the first mounting plate and a second extending hole on a bottom of the fixing groove, the fixing member comprises a main body and a fixing portion on the main body, and the receiving hole extends through the main body and the fixing portion, the main body is received in the first extending hole of the first mounting plate, the fixing portion is received in the fixing groove of the second mounting plate and clamped between the first mounting plate and the second mounting plate.

8. The clamping mechanism of claim 1, wherein the pushing member comprises a pushing portion and a connecting portion protruding from an end of the pushing portion, the pushing assembly further comprises a sliding post extending through the connecting portion of the pushing member, the sliding post is slidably mounted on the adjusting seat and resisted by the elastic member.

9. The clamping mechanism of claim 8, wherein the adjusting seat comprises a resisting portion and an adjusting portion coaxially protruding from an end of the resisting portion, the resisting portion defines a receiving groove axially, the sliding post and the elastic member are received in the receiving groove.

10. The clamping mechanism of claim 9, wherein the resisting portion further defines a pair of sliding holes on a periphery thereof, the pair of sliding holes is opposite to each other and communicates with the receiving groove, opposite ends of the sliding post are slidably received in the pair of sliding holes, the pushing assembly further comprises an adjusting plate defining a screw hole thereon, the adjusting portion of the adjusting seat is screwed in the screw hole of the adjusting plate.

11. A clamping mechanism for holding a workpiece having a hole therein, comprising:
a supporting seat;
a clamping assembly, comprising:
a fixing member fixedly received in the supporting seat and defining a receiving hole thereon;
a plurality of clamping members partially received in the receiving hole and protruding out of the supporting seat; and
a limiting member sleeved on a periphery of the plurality of clamping members;
a pushing assembly comprising:
an adjusting seat;
an elastic member received in the adjusting seat; and
a pushing member comprising a pushing portion and a connecting portion protruding from an end of the pushing portion, wherein the connecting portion is partially received in the adjusting seat and resists the elastic member, the pushing portion is surrounded by the plurality of clamping members, when the supporting seat resists the workpiece, the adjusting seat pushes the pushing member by the elastic member to resist the plurality of clamping members, such that the plurality of clamping members rotate outwardly away from each other to resist an inner sidewall of the hole of the workpiece, thereby holding the workpiece.

12. The clamping mechanism of claim 11, wherein each clamping member comprises a base body and a clamping portion protruding from an end of the base body, the base body is rotatably received in the receiving hole, and the clamping portion is bent relative to the base body, and protrudes out of the fixing member.

13. The clamping mechanism of claim 11, wherein each clamping member defines a resisting surface, the resisting surfaces are inclined toward the pushing member, and the pushing member resists the plurality of clamping members by the resisting surfaces.

14. The clamping mechanism of claim 11, further comprising a plurality of linking members, wherein each linking member is received in the receiving hole and extends through one corresponding clamping member, opposite ends of each linking member are rotatably connected to the fixing member.

15. The clamping mechanism of claim 12, wherein the base body of the clamping member defines a mounting groove at an outer periphery thereon, the mounting grooves of the plurality of clamping members cooperatively form a mounting space, the limiting member is received in the mounting space to limit a rotation angle of the plurality of clamping members away from each other.

16. The clamping mechanism of claim 11, wherein the supporting seat comprises a first mounting plate and a second mounting plate laminated on the first mounting plate, the second mounting plate is located at a side of the first mounting plate away from the adjusting seat, the fixing member is received in the first and the second mounting plates.

17. The clamping mechanism of claim 16, wherein the first mounting plate defines a first extending hole thereon, the second mounting plate defines a fixing groove facing the first mounting plate and a second extending hole on a bottom of the fixing groove, the fixing member comprises a main body and a fixing portion on the main body, and the receiving hole extends through the main body and the fixing portion, the main body is received in the first extending hole of the first mounting plate, the fixing portion is received in the fixing groove of the second mounting plate and clamped between the first mounting plate and the second mounting plate.

18. The clamping mechanism of claim 11, wherein the pushing assembly further comprises a sliding post extending through the connecting portion of the pushing member, the sliding post is slidably mounted on the adjusting seat and resisted by the elastic member.

19. The clamping mechanism of claim 18, wherein the adjusting seat comprises a resisting portion and an adjusting portion coaxially protruding from an end of the resisting portion, the resisting portion defines a receiving groove axially, the sliding post and the elastic member are received in the receiving groove.

20. The clamping mechanism of claim 19, wherein the resisting portion further defines a pair of sliding holes on a periphery thereof, the pair of sliding holes is opposite to each other and communicates with the receiving groove, opposite ends of the sliding post are slidably received in the pair of sliding holes, the pushing assembly further comprises an adjusting plate defining a screw hole thereon, the adjusting portion of the adjusting seat is screwed in the screw hole of the adjusting plate.
